(19) United States
(12) Patent Application Publication
(10) Pub. No.: US 2012/0137439 A1
(43) Pub. Date: Jun. 7, 2012

(54) THIN FOOTBOARD FOR CHAIR EGRESS

(76) Inventor: Richard H. Heimbrock, Cincinnati, OH (US)

(21) Appl. No.: 12/957,531

(22) Filed: Dec. 1, 2010

(51) Int. Cl. A61G 7/015; A61G 7/05

(52) U.S. Cl. 5/618

(57) ABSTRACT

A patient support apparatus is convertible between a horizontal bed position, having a generally horizontal sleeping surface upon which a person lies in a supine position, and a chair egress position, allowing a person to exit the support from a sitting position. The patient support comprises a deck and a footboard pivotably coupled to the deck. The foot panel may engage the floor and allow a low seated height while the bed is in the chair egress position.

### BACKGROUND

The present disclosure relates to a patient support apparatus, such as a hospital bed, for supporting a patient. More particularly, the present disclosure relates to a footboard for a patient support apparatus.

Some hospital beds move between a horizontal bed position, wherein the patient support surface is generally flat, and a chair egress position, wherein the foot-end portion of the patient support surface is lowered so that a patient can egress or exit the bed from a sitting position. The length of the foot-end portion of the patient support surface that is lowered typically defines the minimum seat height of a bed in the chair egress position.

When the foot-end of the patient support surface is lowered, it may be necessary to remove the footboard. This may reduce the minimum seat height. In addition, the footboard may present an obstruction to a patient egressing from the foot end of the patient support apparatus when the patient support apparatus is in a chair egress position.

### SUMMARY

The present application discloses one or more of the features recited in the appended claims and/or the following features which, alone or in any combination, may comprise patentable subject matter.

According to one aspect of the disclosure, a patient support apparatus includes a deck having a head end and a foot end, a footboard, and an actuator. The deck is movable between a horizontal bed position, where the deck is configured to support a patient in the supine position, and a chair egress position, where the foot end of the deck is lowered so that a patient can exit the bed from a sitting position. The footboard is coupled to the foot end of the deck for pivotable movement relative to the deck. The actuator is operable to drive the footboard to pivot relative to the foot end of the deck into a position engaging the floor when the deck is in the chair egress position so that a patient can step on the footboard while exiting the deck without further pivoting of the footboard relative to the deck.

In some embodiments, the deck may include a footboard position sensor configured to determine an angle formed by the footboard relative to the deck.

The footboard may form an obtuse angle with the deck when the deck is in the chair egress position.

The foot end of the deck may be spaced apart from the floor when the deck is in the chair egress position.

The actuator may be operable to drive the footboard to pivot relative to the foot end of the deck away from engagement with the floor when the deck moves away from the chair egress position.

The deck may include a head deck section, a seat deck section, a thigh deck section, and a foot deck section. The deck may have a head deck position sensor configured to determine the angle formed by the head deck section and the seat deck section. The deck may further have a foot deck position sensor configured to determine the angle formed by the thigh deck section and the foot deck section.

The footboard may include a footboard position sensor configured to determine an angle formed by the foot deck and the footboard.

The patient support apparatus may further comprise a controller operable to control the actuator and in communication with the head deck position sensor, the foot deck position sensor, and the footboard position sensor.

The footboard may be rigidly constructed of a composite material such as carbon fiber and may be about one-eighth of an inch thick.

The foot end edge of the footboard may engage the floor when the deck is in the chair egress position.

The footboard may include an obstruction sensor operable to pause the operation of the actuator. The obstruction sensor may be coupled to the foot end of the footboard.

According to another aspect, patient support apparatus includes a deck having a head end and a foot end and a footboard coupled to the deck. The deck includes a footboard position sensor configured to determine an angle formed by the foot deck and the footboard. The deck is also movable between a horizontal bed position, wherein the deck is configured to support a patient in the supine position, and a chair egress position, wherein the foot end of the deck is lowered so that a patient can exit the bed from a sitting position.

The footboard may engage the floor when the deck is in the chair egress position.

The patient support apparatus may further include an actuator operable to drive the footboard to pivot relative to the foot end of the deck into a position engaging the floor when the deck is in the chair egress position so that a patient can step on the footboard while entering the deck without further pivoting of the footboard relative to the deck.

The footboard may be about one-eighth of an inch thick and rigid.

### BRIEF DESCRIPTION OF THE DRAWINGS

The detailed description particularly refers to the accompanying figures, in which:

FIG. 1 is a perspective view of a patient support apparatus embodied as a hospital bed showing the bed in a horizontal bed position and including a footboard coupled to a foot end of a deck of the bed;

FIG. 2 is a perspective view of the bed of FIG. 1 showing the bed in a chair egress position wherein the footboard is engaging the floor;

FIG. 3 is a side view of the bed of FIG. 1 showing the bed in a chair egress position wherein the top edge of the footboard is engaging the floor;

FIG. 4 is a side view of the bed of FIG. 1 showing an another chair egress position wherein the foot end of the footboard is engaging the floor; and

FIG. 5 is a schematic view of the bed of FIG. 1.

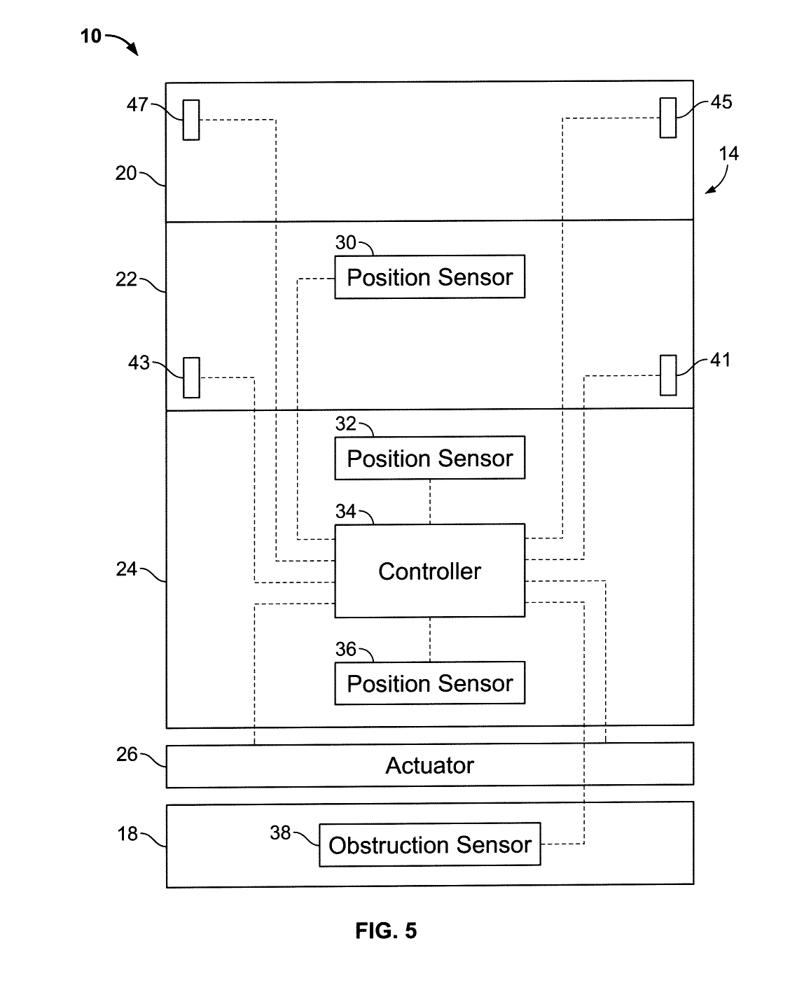

### DETAILED DESCRIPTION OF THE DRAWINGS

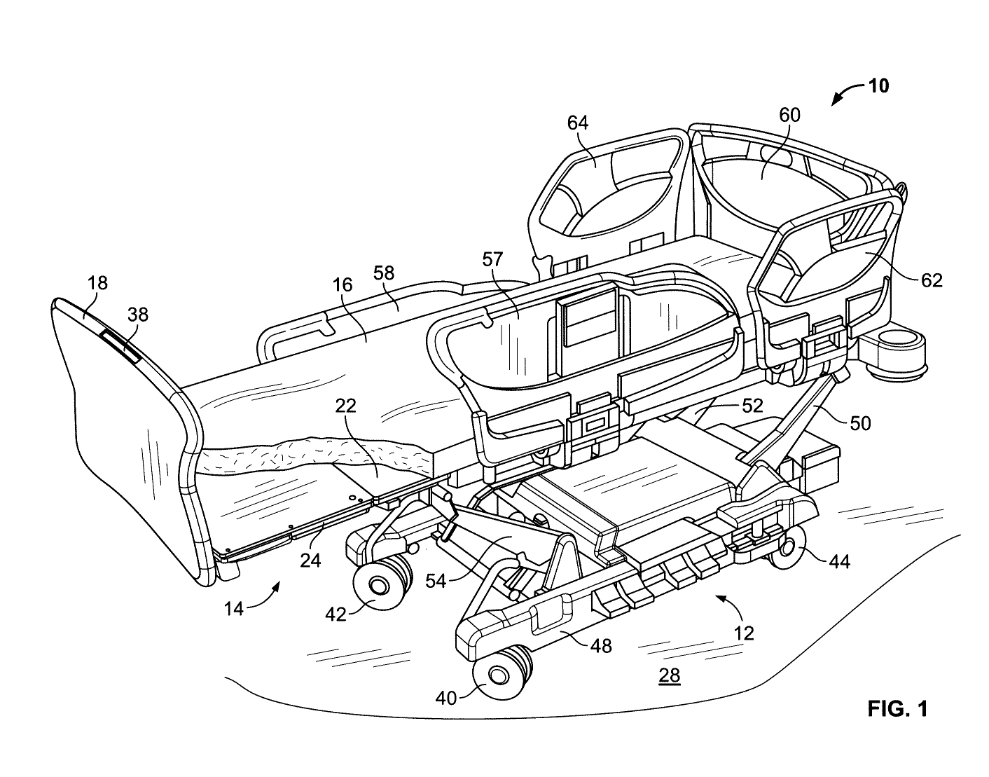

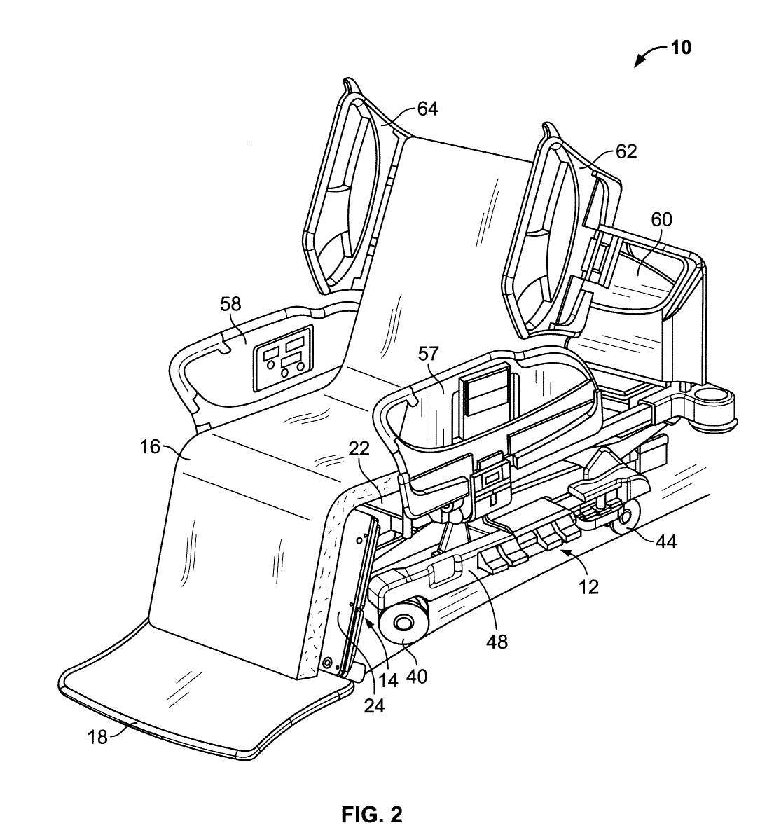

A patient support apparatus is illustratively embodied as a hospital bed 10 having a base 12, a deck 14, and a mattress assembly 16 as shown in FIG. 1. The deck 14 is supported by the base 12. The deck 14 supports the mattress assembly 16. The bed 10 is movable between a horizontal bed position, shown in FIG. 1, wherein the deck 14 is generally flat, and a chair egress position, shown in FIG. 2, wherein the bed 10 is configured to allow a patient to egress or exit the foot end of the bed 10 from a sitting position.

The bed 10 includes a footboard 18. The footboard 18 is coupled to the foot end of the deck 14 for pivotable movement relative to the deck 14. In the illustrative embodiment, the footboard 18 is about one-eighth of an inch thick. In other embodiments, the footboard 18 is less than one inch thick. Additionally, the footboard 18 is rigid. Illustratively, the footboard 18 is constructed from a carbon fiber composite material. In other embodiments, the footboard 18 is constructed from other rigid composite materials such as fiberglass or from other appropriate materials, including other polymeric or metallic materials.

The deck 14 comprises a head deck section 20, a seat deck section 22, a thigh deck section 23, and a foot deck section 24. The head deck section 20 is pivotably coupled to the seat deck section 22. The seat deck section 22 is pivotably coupled to the thigh deck section 23. The thigh deck section 23 is coupled to the foot deck section 24. The foot deck section 24 is movable between an extended position, where the foot end of the foot deck section 24 is extended away from the foot end of the seat deck section 22, and a retracted position, where the foot end of the foot deck section 24 is retracted toward the seat deck section 22. When the bed 10 is in the horizontal bed position, the foot deck section 24 may be moved to the extended position. When the bed 10 is in the chair egress position, the foot deck section 24 is moved to the retracted position to allow the bed 10 to be lowered to minimize the distance 29 between the floor 28 and the top of the mattress assembly 16 supported on the seat deck section 22.

The footboard 18 is pivotably coupled to the foot deck section 24 by an actuator 26. The actuator 26 is operable to drive the footboard 18 to a plurality of positions at angles relative to the foot deck section 24. The actuator 26 maintains the footboard 18 in positions relative to the foot deck section 24. In the illustrative embodiment, the actuator 26 is a stepper motor capable of being moved to a plurality of different positions. In other embodiments the actuator 26 may include a linkage. The actuator 26 may comprise an electromechanical structure such as motor powered drive screw to move the linkage, and, thereby, the footboard 18. In some embodiments, the actuator 26 may comprise a hydraulically actuated device.

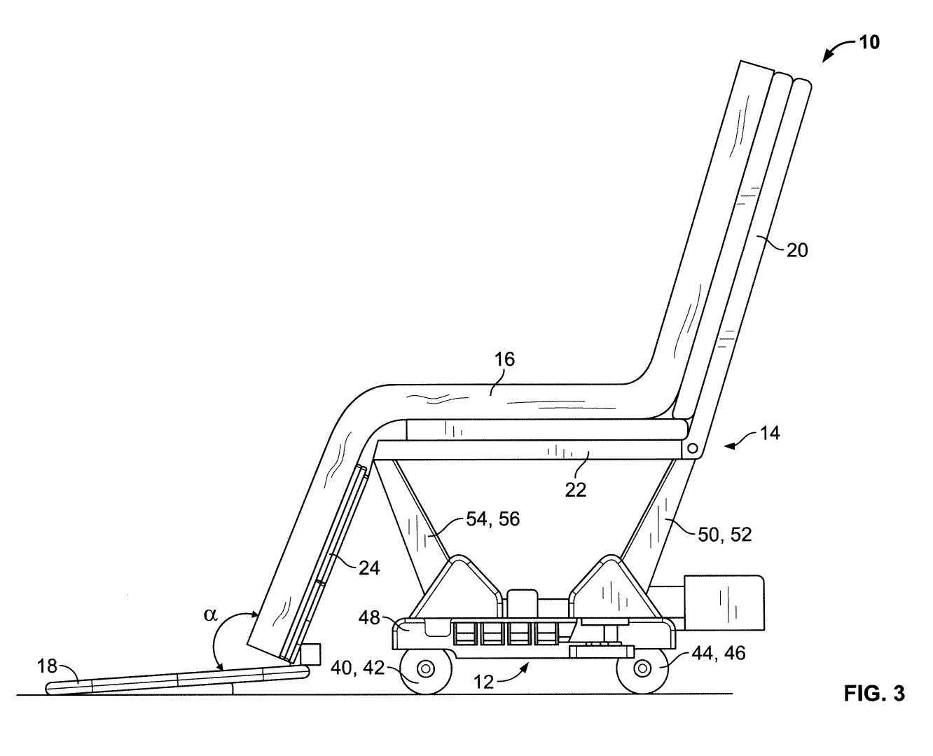

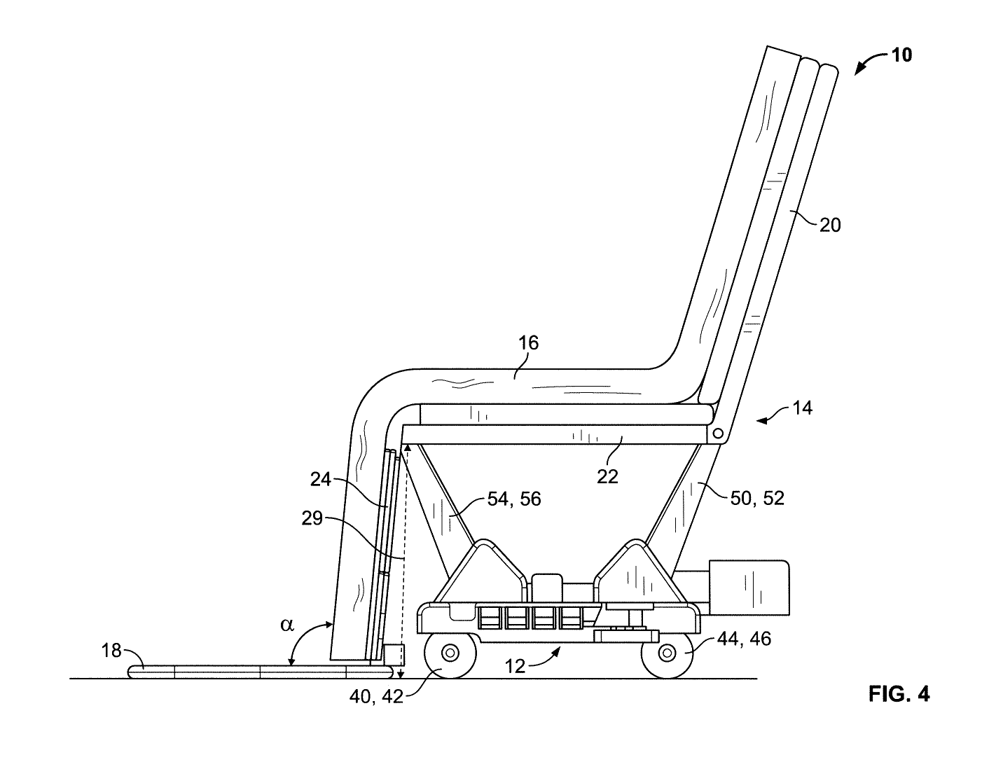

When the bed 10 is in the horizontal bed position, the actuator 26 drives the footboard 18 to a first position where the footboard 18 extends generally perpendicularly from the foot deck section 24 and above the top surface of the mattress assembly 16, when the mattress assembly 16 is present. When the bed 10 is in the chair egress position, the actuator 26 drives the footboard 18 to a second position, where the footboard 18 engages a floor 28 and extends at an obtuse angle a from the foot deck section 24. In one chair egress position, the top edge of the footboard 18 engages the floor 28 as shown in FIG. 3. In another chair egress position, the foot end of the footboard 18 engages the floor 28 as shown in FIG. 4.

While the bed 10 is in the chair egress position, a minimum height 29 of the seat deck section 22 is determined by the distance between the foot end of the seat deck section 22 and the foot end of the bed 10. While the footboard 18 is coupled to the deck 14, the foot end of the bed 10 is defined by the foot end of the footboard 18. Thus, the minimum distance between the foot end of the seat deck section 22 and the foot end of the bed 10 is the length of the foot deck section 24 along with the thickness of the footboard 18 as shown in FIG. 4. Thus, in some embodiments, the footboard 18 with less than one inch thickness dimension contributes only a small amount to the minimum height 29 of the seat deck section 22 while the bed 10 is in the chair egress position.

The deck 14 further includes a head deck position sensor 30, a foot deck position sensor 32, and a controller 34. In the illustrative embodiment, the head deck position sensor 30 and the foot deck position sensor 32 are potentiometers. In other embodiments, other position sensors may be used in place of the potentiometers. The head deck position sensor 30 is configured to determine the angle formed by the head deck section 20 and the seat deck section 22. The foot deck position sensor 32 is configured to determine the angle formed by the thigh deck section 23 and the foot deck section 24. The head deck position sensor 30 and the foot deck position sensor 32 are in communication with the controller 34.

The deck 14 also includes a footboard position sensor 36. The footboard position sensor 36 is also a potentiometer. In other embodiments, other suitable sensors, such as accelerometers, for example, are used. The footboard position sensor 36 is configured determine the angle formed by the foot deck section 24 and the footboard 18. The footboard position sensor 36 is in communication with the controller 34 and the controller 34 utilizes the position information about the position of the footboard 18 to determine if it is acceptable to allow other components of the bed 10 move, or if there is a risk of contact between members of the bed 10.

The controller 34 is in communication with the actuator 26 and directs the actuator 26 to drive the footboard 18 between the first and the second position. When the head deck position sensor 30 and the foot deck position sensor 32 indicate that the head deck section 20 and the foot deck section 24 are at a preprogrammed pair of angles, the controller 34 determines that the bed 10 is in the chair egress position. When the controller 34 determines that the bed 10 is in the chair egress position, the controller 34 directs the actuator 26 to drive the footboard 18 to the second position. When the controller 34 determines that the bed 10 is not in the chair egress position, the controller 34 directs the actuator 26 to drive the footboard 18 to the first position. Thus, the footboard 18 is engaged with the floor 28 when the bed 10 is in the chair egress position and does not present a tripping hazard above the floor 28. Further, the footboard 18 is generally perpendicular to the foot deck section 24 when the bed 10 is at any orientation other than the chair egress position so that the footboard 18 prevents the mattress assembly 16, when present, from slipping toward the foot end of the deck 14.

The footboard 18 includes an obstruction sensor 38. The obstruction sensor 38 is a switch coupled to the footboard 18 and in communication with the controller 34. In other embodiments, the obstruction sensor 38 is a proximity sensor or some other suitable sensor. The obstruction sensor 38 is configured to detect an object between the footboard 18 and the floor 28 in the path of the footboard 18 as the footboard 18 moves from the first position to the second position. When an object, is detected by the obstruction sensor 38, the controller 34 directs the actuator 26 to pause driving the footboard 18. In some embodiments, when the controller 34 detects an object, the controller 34 directs the actuator 26 to reverse the movement of the footboard 18. Objects such as a caregiver's foot, a piece of hospital equipment, a cable, and other items are detectable by the obstruction sensor 38.

The base 12 includes a first caster 40, a second caster 42, a third caster 44 a fourth caster (not shown), and a base frame 48. The casters 40, 42, 44, are coupled to the base frame 48 and engage the floor 28 to allow rolling movement of the bed 10 along the floor 28. The first caster 40 includes a first caster brake actuator 41. The second caster 42 includes a second caster brake actuator 43. The third caster 44 includes a third caster brake actuator 45. The fourth caster includes a fourth caster brake actuator 47. The caster brake actuators 41, 43, 45, 47, are in communication with the controller 34. The controller 34 directs the caster brake actuators 41, 43, 45, 47, to move between a locked condition and an unlocked condition. In the locked condition, caster brake actuators 41, 43, 45, 47, brake the casters 40, 42, 44, from rolling relative to the floor 28.

The base 12 further includes a first head end strut 50, a second head end strut 52, a first foot end strut 54, and a second foot end strut (not shown). The first and the second head-end struts 50, 52, are coupled to the head-end of base frame 48 and to the deck 14 near the head end of the deck 14. The first foot end strut 54 and the second foot-end strut are coupled to the foot-end of the base frame 48 and to the deck 14 such that the foot-end of the deck 14 is cantilevered over the base 12.

The bed 10 includes a first siderail 57, a second siderail 58, and a user input 59. The first and the second siderails 57, 58, extend generally perpendicularly to the footboard 18, when the footboard 18 is in the first position, along the deck 14. The first and the second siderails 57, 58, extend above the top surface of the mattress assembly 16, when the mattress assembly 16 is present, and are adjustable across a predetermined range of heights. The user input 59 is mounted on the first siderail 57 and is an LCD touch screen. The user input 59 displays icons corresponding with the horizontal bed position and the chair egress position and is in communication with the controller 34.

The bed 10 also includes a headboard 60, a first headrail 62, and a second headrail 64. The headboard 60 extends along the head end of the deck 14 and extends above the mattress assembly 16, when the mattress assembly 16 is present. The first and the second headrails 62, 64, extend generally perpendicularly to the headboard 60 and the first and the second siderails 57, 58. The first and the second headrails 62, 64, extend above the top surface of the mattress assembly 16, when the mattress assembly 16 is present, and are adjustable across a predetermined range of heights. Also, the headboard 60 is removable from the bed 10.

During operation of the hospital bed 10 if a caregiver decides to reposition the hospital bed 10 from the horizontal bed position to the chair egress position the caregiver selects the chair egress position icon on the user input 59. When the chair egress icon is selected, the head deck section 20 and the foot deck section 24 articulate from the horizontal bed position to the chair egress position.

If a caregiver decides to reposition the hospital bed 10 from the chair egress position to the horizontal bed position the caregiver selects the horizontal bed position icon on the user input 59. When the chair egress icon is selected, the footboard 18 is articulated away from engagement with the floor and into the first position. When the footboard 18 is in the first position, the head deck section 20 and the foot deck section 24 articulate from the horizontal bed position to the chair egress position. Thus, when the bed 10 moves from the chair egress position to the horizontal bed position the footboard 18 is out of contact with the floor 28.

Although certain illustrative embodiments have been described in detail above, variations and modifications exist within the scope and spirit of this disclosure as described and as defined in the following claims.

1. A patient support apparatus comprising
a deck having a head end and a foot end, the deck movable between a horizontal bed position, wherein the deck is configured to support a patient in the supine position, and a chair egress position, wherein the foot end of the deck is lowered so that a patient can exit the patient support apparatus from a sitting position,
a footboard coupled to the foot end of the deck for pivotable movement relative to the deck, and
an actuator operable to drive the footboard to pivot relative to the foot end of the deck into a position engaging the floor when the deck is in the chair egress position so that a patient can step on the footboard while exiting the deck without further pivoting of the footboard relative to the deck.

2. The patient support apparatus of claim 1, wherein the deck includes a footboard position sensor configured to determine an angle formed by the footboard relative to the deck.

3. The patient support apparatus of claim 1, wherein the footboard forms an obtuse angle with the deck when the deck is in the chair egress position.

4. The patient support apparatus of claim 1, wherein the foot end of the deck is spaced apart from the floor when the deck is in the chair egress position.

5. The patient support apparatus of claim 1, wherein the actuator is operable to drive the footboard to pivot relative to the foot end of the deck away from engagement with the floor when the deck moves away from the chair egress position.

6. The patient support apparatus of claim 1, wherein the deck includes a head deck section, a seat deck section, a thigh deck section, and a foot deck section, and the deck further includes a head deck position sensor, configured to determine the angle formed by the head deck section and the seat deck section, and a foot deck position sensor, configured to determine the angle formed by the thigh deck section and the foot deck section.

7. The patient support apparatus of claim 6, wherein the footboard includes a footboard position sensor configured to determine an angle formed by the foot deck section and the footboard.

8. The patient support apparatus of claim 7, further comprising a controller operable to control the actuator and in communication with the head deck position sensor, the foot deck position sensor, and the footboard position sensor.

9. The patient support apparatus of claim 1, wherein the footboard is rigid.

10. The patient support apparatus of claim 9, wherein the footboard is about one-eighth of an inch thick.

11. The patient support apparatus of claim 10, wherein the footboard is constructed from a composite material.

12. The patient support apparatus of claim 10, wherein the footboard is constructed from carbon fiber.

13. The patient support apparatus of claim 1, wherein the foot end edge of the footboard engages the floor when the deck is in the chair egress position.

14. The patient support apparatus of claim 1, wherein the footboard includes an obstruction sensor operable to pause the operation of the actuator.

15. The patient support apparatus of claim 14, wherein the obstruction sensor is coupled to the foot end of the footboard.

16. A patient support apparatus comprising
a deck having a head end and a foot end, the deck movable between a horizontal bed position, wherein the deck is configured to support a patient in the supine position, and a chair egress position, wherein the foot end of the deck is lowered so that a patient can exit the patient support apparatus from a sitting position, and
a footboard coupled to the foot end of the deck for pivotable movement relative to the deck,
wherein the deck includes a footboard position sensor configured to determine an angle formed by the foot deck section and the footboard.

17. The patient support apparatus of claim 16, wherein the footboard engages the floor when the deck is in the chair egress position.

18. The patient support apparatus of claim 16, further comprising an actuator operable to drive the footboard to pivot relative to the foot end of the deck into a position engaging the floor when the deck is in the chair egress position so that a patient can step on the footboard while entering the deck without further pivoting of the footboard relative to the deck.

19. The patient support apparatus of claim 18, wherein the footboard is about one-eighth of an inch thick.

20. The patient support apparatus of claim 19, wherein the footboard is rigid.
